(19) United States
(12) Patent Application Publication
(10) Pub. No.: US 2002/0123987 A1
(43) Pub. Date: Sep. 5, 2002

(54) Nearest neighbor data method and system

(76) Inventor: James A. Cox, Raleigh, NC (US)

Correspondence Address: Jones, Day, Reavis & Pogue, North Point, 901 Lakeside Avenue, Cleveland, OH, 44114, US

(21) Appl. No.: 09/764,742

(22) Filed: Jan. 18, 2001

(51) Int. Cl. G06F 7/00

(52) U.S. Cl. 707/3

(57) ABSTRACT

A computer-implemented multi-dimensional search method and system that searches for nearest neighbors of a probe data point. Nodes in a data tree are evaluated to determine which data points neighbor a probe data point. To perform this evaluation, the nodes are associated with ranges for the data points included in their respective branches. The data point ranges are used to determine which data points neighbor the probe data point. The top “k” data points are returned as the nearest neighbors to the probe data point.

### BACKGROUND OF THE INVENTION

1. Technical Field

The present invention is generally directed to the technical field of computer search algorithms, and more specifically to the field of nearest neighbor queries.

2. Description of the Related Art

Nearest neighbor queries have been an important and intuitively appealing approach to pattern recognition from its inception. The problem is typically stated as: given a set of records, find the k most similar records to a given query record. Once these most similar records have been obtained, they can either be used directly, in a “closest-match” situation, or alternatively, as a tool for categorization, by having each of the examples vote on its category membership. Potential applications for nearest neighbor queries include predictive modeling, fraud detection, product catalog navigation, fuzzy matching, noisy merging, and collaborative filtering.

For example, a prospective customer may wish to purchase one or more books through a web site. To determine what books the prospective customer might wish to purchase, the attributes of the prospective customer are compared with the attributes of previous customers that are stored in memory. The attributes to be compared may include age, education, hobbies, geographical home location, etc. A set of nearest neighbors are selected based upon the closest age, education, hobbies, geographical home, etc.

However, in the pattern recognition community, neural networks, decision trees, and regression are often preferred to memory-based reasoning, or the use of nearest neighbor techniques for predictive modeling. This is probably due to the difficulty of applying a nearest neighbor technique when scoring new records. For each of these “competitors” of the nearest neighbor technique, scoring is straightforward, compact, and fast. Nearest neighbor techniques typically require a set of records to be accessed at scoring time, and in most real-world situations, also require comparison of a probe item to each item in the set. This is clearly impractical for any training set of substantial size.

These approaches all assume that the data is spatially partitioned in some way, either in a tree or index (or hash) structure. The partitions may be rectangular in shape (e.g., KD-Trees, R-Trees, BBD-Trees), spherical (e.g., SS-Trees, DBIN), or a combination (e.g., SR-Trees). All of these approaches can find nearest neighbors in time proportional to the log of the number of training examples, assuming that the size of the data is sufficiently large and the dimensionality is sufficiently small. However, a phenomenon known as boundary effects occur as dimensionality increases, and it has been proven that the minimum number of nodes examined, regardless of the algorithm, must grow exponentially with regards to the dimensionality d.

The first of these techniques was known as the KD-Tree, which was originally proposed by Bentley (1975) (see the following references: Bentley, J. L. “Multidimensional binary search trees used for associative searching”, Communications of the ACM, 18, (Sep. 9, 1975), 509-517; and Friedman, J. H., Bentley, J. L. & Finkel, R. A. “An Algorithm for Finding Best Matches in Logarithmic Expected Time”, ACM Transactions on Mathematical Software, 3, (Sep. 3, 1977), 209-226.). It creates a binary tree by repeatedly partitioning the data. It splits a node along some dimension, usually the one with the greatest variation for observations in that node. Generally this split occurs at the selected dimension's median value, so half the observations go into one descendant and half into the other descendant node. When searching such a structure for the nearest neighbors to a probe point, one can descend to the leaf node containing that point, measure distances from the probe point to each of the points in that leaf, and then backtrack through the tree, examining points until the “k-th” to the smallest distance so far exceeds the minimum distance to points that would be contained in that node or its descendants.

FIG. 1 shows a potential breakdown of points in a two-dimensional space using a KD-Tree. Note how it recursively divides and subdivides regions. If there is a probe point in the bottom left (as shown by reference numeral 10), there is no need to compare its distance to points in the upper right (as shown by reference numeral 12).

Weber, et. al. (1998) has shown that, with random uniform data, the minimum number of nodes examined with a KD-Tree using the L₂ metric is proportional to 2^{d} (see the following reference: R. Weber, H. -J. Schek and S. Blott, “A Quantitative Analysis and Performance Study for Similarity-Search Methods in High-Dimensional Spaces”, Proceedings of the International Conference on Very Large Databases, 1998. This makes the KD-Tree approach disadvantageous with more than 15-20 dimensions.

The other methods mentioned above are attempts to improve on a KD-Tree, but they all have essentially the same limitation. R-Trees and BBD-Trees have partitions along more than one axis at a time, but then more than one dimension has to be processed at every split. So their incremental gain really only occurs when the data is stored on disk and they can suffer in comparison to KD-Tree when data is maintained in memory. The spherical access methods do hit boundary conditions at a slightly higher dimensionality than KD-Trees, due to the greater efficiency of spherical partitioning, but the space can not be completely partitioned spherically, so that adds additional difficulties.

### SUMMARY OF THE INVENTION

The present invention solves the aforementioned disadvantages as well as other disadvantages of the prior approaches. In accordance with the teachings of the present invention, a computer-implemented set query method and system that searches for nearest neighbors of a probe data point. Nodes in a data tree are evaluated to determine which data points neighbor a probe data point. To perform this evaluation, the nodes are associated with ranges for the data points included in their respective branches. The data point ranges are used to determine which data points neighbor the probe data point. The top “k” data points are returned as the nearest neighbors to the probe data point.

### BRIEF DESCRIPTION OF THE DRAWINGS

The present invention satisfies the general needs noted above and provides many advantages, as will become apparent from the following description when read in conjunction with the accompanying drawings, wherein:

FIG. 1 is a graph showing a partitioning of points in two-dimensional space using a KD-Tree approach;

FIG. 2 is a system block diagram depicting the nearest neighbor search environment of the present invention;

FIG. 3 is a tree diagram depicting an exemplary splitting of nodes;

FIGS. 4 and 5 are detailed depictions of a branch of the tree in FIG. 3;

FIG. 6 is a graph showing a partitioning of points in two-dimensional space using the present invention;

FIG. 7 is a flow chart depicting pre-processing of data in order to store the data in the tree of the present invention;

FIGS. 8 and 9 are flow charts depicting the steps to add a point to the tree of the present invention;

FIG. 10 is a flow chart depicting the steps to locate the nearest neighbor in the tree of the present invention; and

FIGS. 11-13 are x-y graphs that compare speed of nearest neighbor matching for scanning, KD-Tree, and the present invention at different numbers of dimensions.

### DETAILED DESCRIPTION OF THE PREFERRED EMBODIMENT

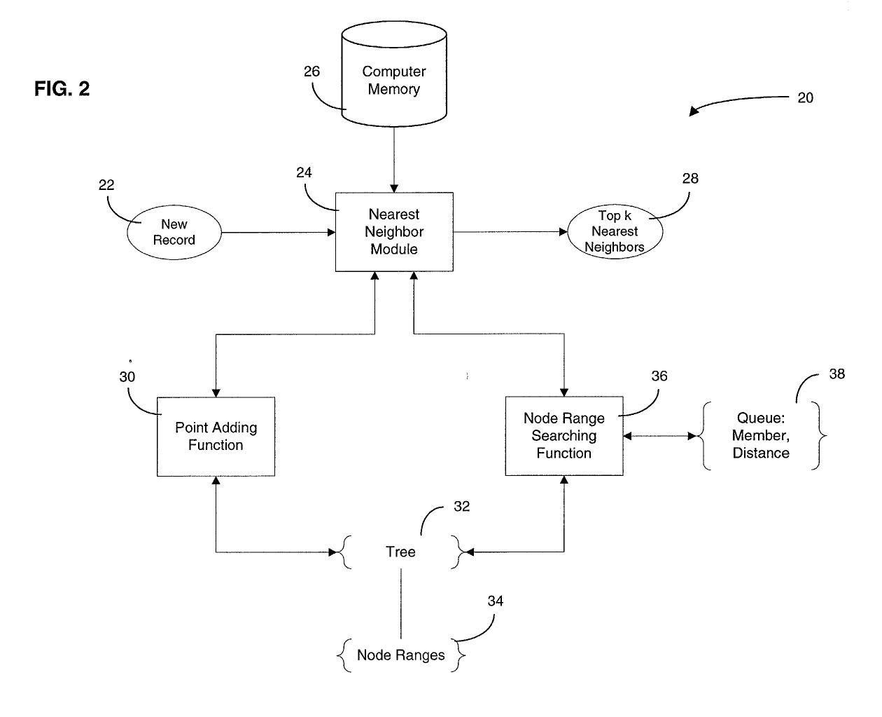

FIG. 2 depicts generally at 20 the nearest neighbor computer system of the present invention. A new record 22 is sent to the nearest neighbor module 24 of the present invention so that records most similar to the new record can be located in computer memory 26. Computer memory 26 preferably includes any type of computer volatile memory, such as RAM (random access memory). Computer memory 26 may also include non-volatile memory, such as a computer hard drive or data base, as well as computer storage that is used by a cluster of computers. The preferred use for the present invention is as an in-memory searching technique. However, it should be understood that the present invention is not limited to an in-memory searching technique but also includes iteratively accessing computer storage (e.g., a database) in order to perform the searching method of the present invention.

When the new record 22 is presented for pattern matching, the distance between it and similar records in the computer memory 26 is determined. The records with the kth smallest distance from the new record 22 are identified as the most similar (or nearest neighbors). Typically, the nearest neighbor module returns the top k nearest neighbors 28.

First, the nearest neighbor module 24 uses the point adding function 30 to partition data from the database 26 into regions. The point adding function 30 constructs a tree 32 with nodes to store the partitioned data. Nodes of the tree 32 not only store the data but also indicate what data portions are contained in what nodes by indicating the range 34 of data associated with each node.

When the new record 22 is received for pattern matching, the nearest neighbor module 24 uses the node range searching function 36 to determine the nearest neighbors 28. The node range searching function 36 examines the data ranges 34 stored in the nodes to determine which nodes might contain neighbors nearest to the new record 22. The node range searching function 36 uses a queue 38 to keep a ranked track of which points in the tree 32 have a certain minimum distance from the new record 22. The priority queue 38 has k slots which determines the queue's size, and it refers to the number of nearest neighbors to detect. Each member of the queue 38 has an associated real value which denotes the distance between the new record 22 and the point that is stored in that slot.

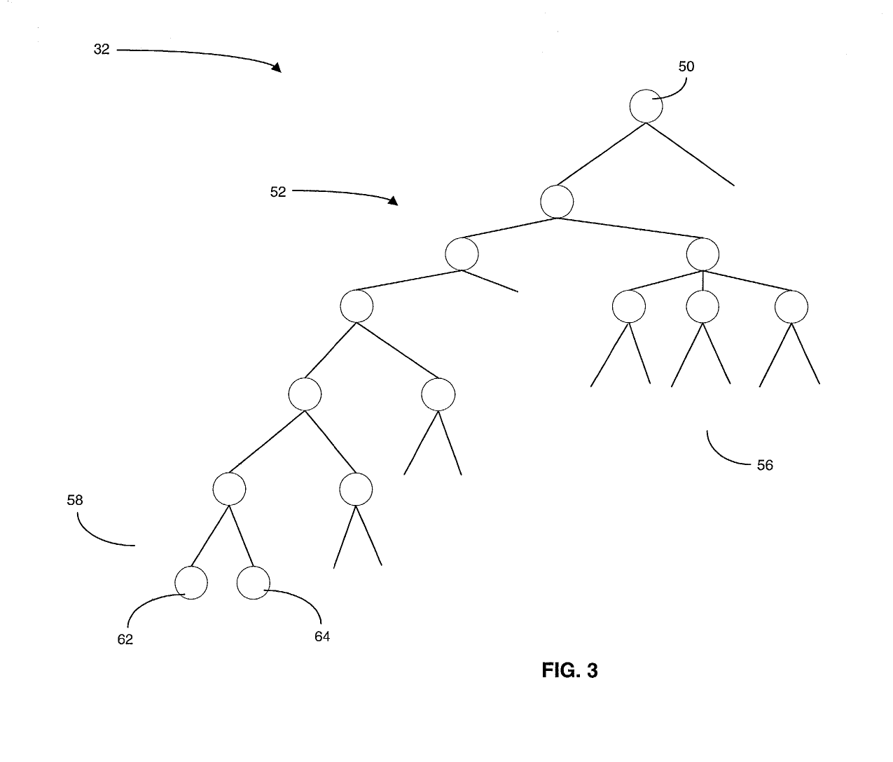

The novel tree 32 is depicted in greater detail in FIGS. 3, 4 and 5. With reference to FIG. 3, the present invention's tree 32 contains a root node 50, branch nodes 52 and leaf nodes, such as leaf nodes 62 and 64. The root node 50 is the entry point to the tree 32. The root node 50 splits at the next level into two or more subnodes 52. The subnodes 52 eventually terminate with leaf nodes, such as leaf nodes 62 and 64.

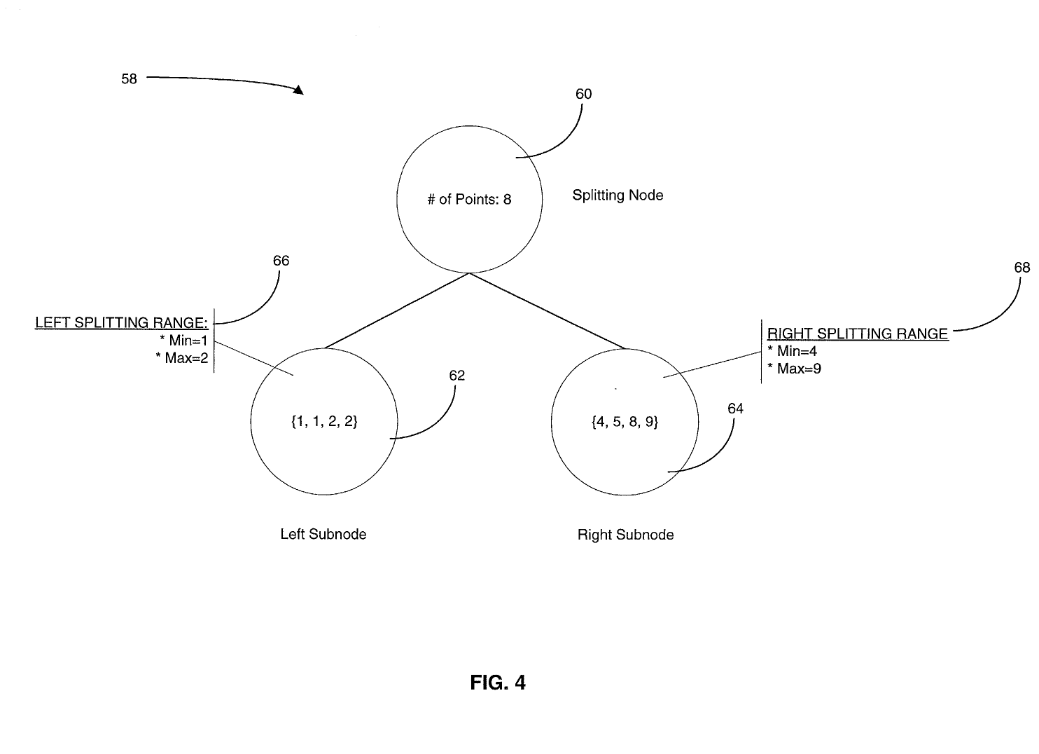

A portion 58 of the tree 32 is depicted in FIG. 4 to describe the splitting technique of the present invention. The subnode 60 splits into two other subnodes 62 and 64. Each subnode includes the range of data contained in that node. Thus for a binary tree structure, the present invention stores four points for each split, and they are stored in the subnodes, rather than in the splitting node. The four points are the minimum and maximum values for each of the subnodes along the dimension where the split took place. This is significantly different from the previous approach, such as the KD-Tree, which stores a single splitting point in the parent node 60 and no ranges. As new observations are added to the tree, these minimum and maximum values update themselves so that they always represent the minimum and maximum value along that particular dimension.

For example, suppose one is splitting along dimension 1, and there are eight points in node 60, which have the following values for dimension 1: 1, 1, 2, 2, 4, 5, 8, and 9. The present invention stores four values—the minimum and maximum of the left subnode 62 which are 1 and 2 respectively (as stored in data structure 66), and for the right subnode 64 they are 4 and 9 respectively (as shown in data structure 68). Note that the KD-Tree would store one split point in the parent node that would never be updated: 3.

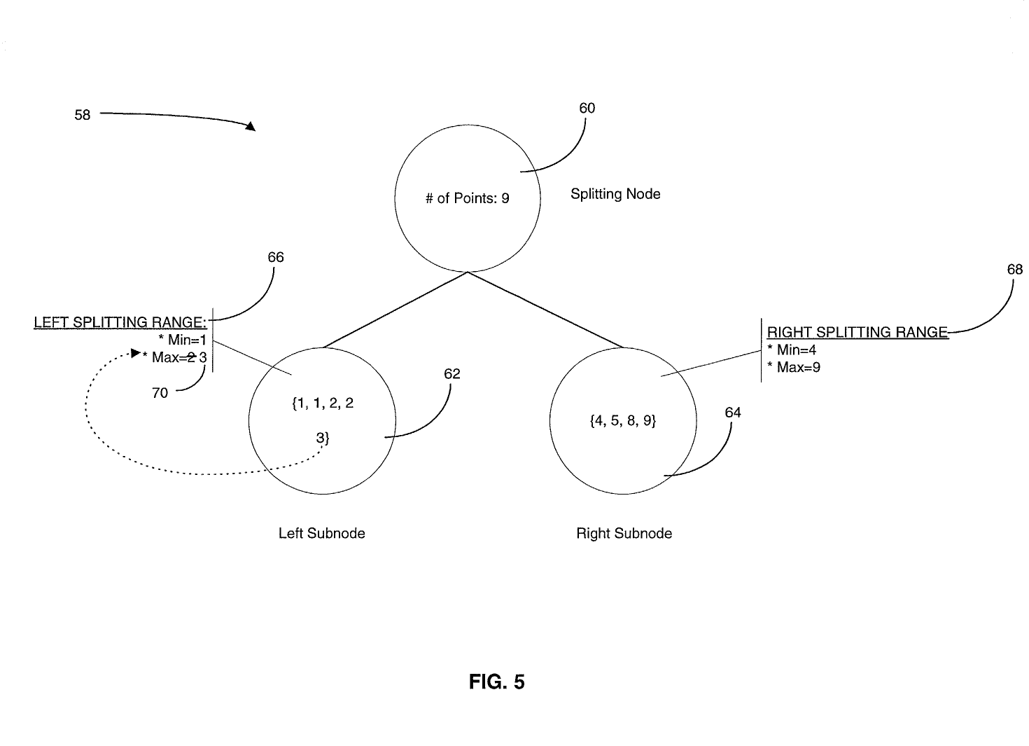

With reference to FIG. 5, suppose another observation is added to the tree later, say with the value 3. In the KD-Tree, it would be added to the left subnode 62, but no values would change. In the present invention, it is added to the left subnode 62, but the left subnode's maximum value would be changed to 3 as shown by reference numeral 70.

For searching, the present invention handles the situation when the probe point does not occur in any of the regions that have been partitioned. When it hits a split where it is below the minimum of the left subnode, it follows the left subnode, calculating a minimum distance to that subnode of the difference between its value on that dimension with the minimum value on that subnode. Similarly, if it is greater than the maximum of the right subnode, it takes that subnode, with a similar calculation of the minimum distance, and when it is between the maximum of the left and the minimum of the right, it takes the node with the smallest minimum distance to expand first. If the probe point is within the range (i.e., the minimum and maximum) of the left branch, then the left branch is followed with a similar distance calculation. If the probe point is within the range (i.e., the minimum and maximum) of the right branch, then the right branch is followed with a similar distance calculation. The minimum distance calculation is more accurate in the present invention as the tree is being searched than in the KD-Tree search algorithm.

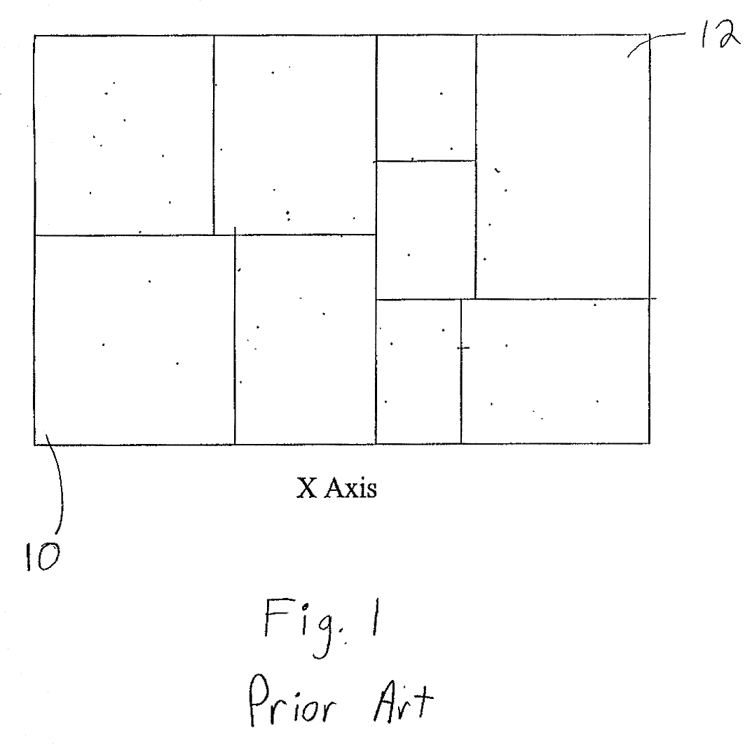

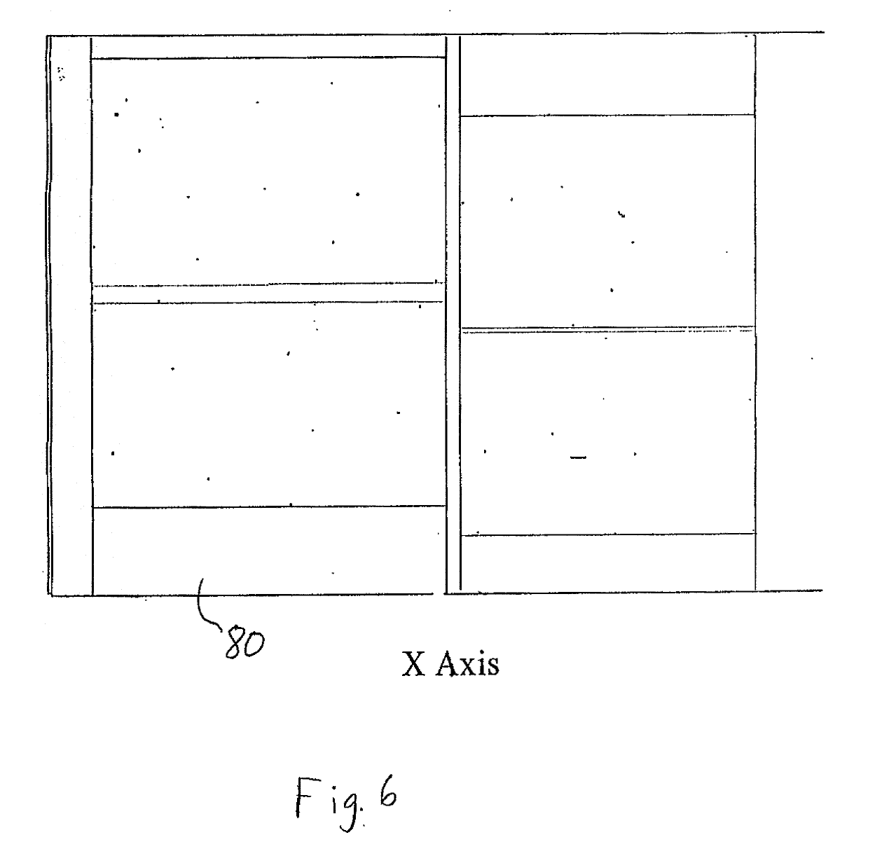

An advantage of the present invention is that empty space is not included in the representation. This leads to smaller regions than in the KD-Tree, allowing branches of the tree to be eliminated more quickly from the search. Thus, search time is improved dramatically. This “squashing” of the regions can be seen in FIG. 6, which represents the present invention's first few splits of the same data that is shown using a KD-Tree in FIG. 1. For example, the present invention's region 80 of FIG. 6 is a more squashed (compressed) region than the KD-Tree's region 10 of FIG. 1. This more compressed nature of the present invention leads to quicker and more efficient nearest neighbor searching.

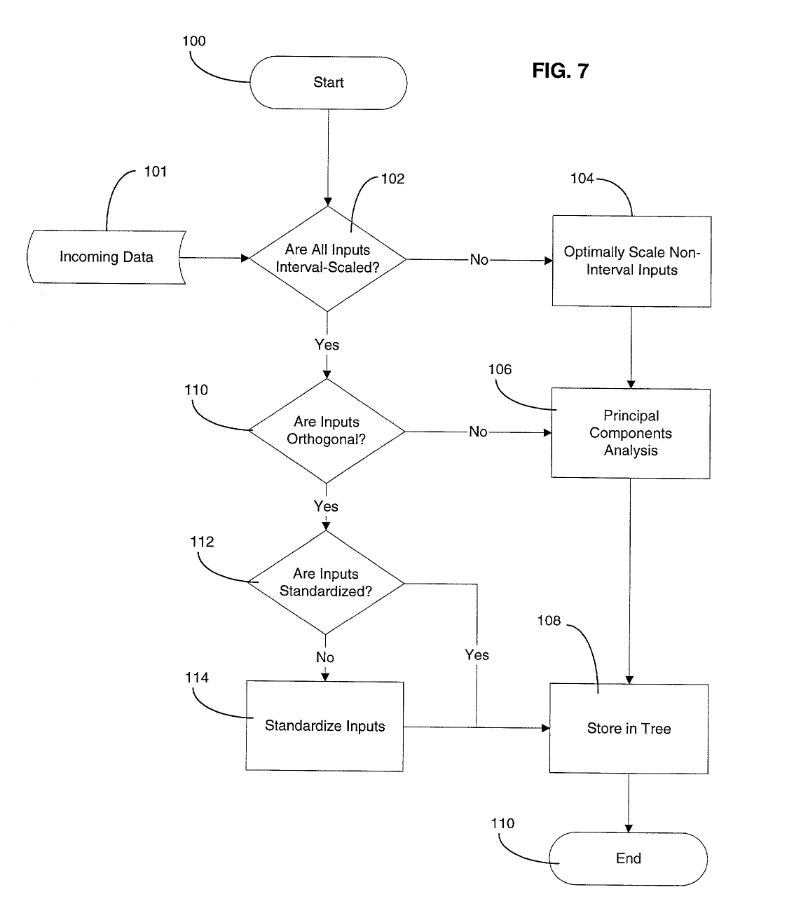

FIG. 7 is a flow chart showing a series of steps for transforming the data into a form that can be stored and used by the present invention. Start block 100 indicates that decision block 102 examines whether all incoming data 101 are interval-scale. Typically a requirement for metric space is that the data satisfy the more restrictive ratio-scale requirement, however in the present invention, since distances between points is the only item of relevance, interval-scaled data is sufficient. Moreover, the position of zero can be arbitrary for the present invention.

If there are some categorical inputs, or the inputs are continuous but not interval, they are scaled into variables that are interval-scaled at block 104. One approach to accomplish this is to “dummy” the variables. This approach takes categorical data and transforms it into a set of binary variables, each one representing a different category. Then the resulting dimensions are analyzed using the spatial techniques described above. However, this greatly expands the number of dimensions and the dimensions are guaranteed not to be independent. A preferred approach is to optimally scale each categorical variable into a single interval-scaled variable where the mapping is an integrative approach that maximizes the sum of the first r eigenvalues of the covariance matrix of all interval variables and the scaling of all non-interval scaled variable (see the following reference: Kuhfeld, W. F., Sarle, W. S. and Young, F. W. “Methods of Generating Model Estimates in the PRINQUAL Macro”, SAS Users Group International Conference Proceedings: SUGI 10, 962-971,1985).

If the inputs are not orthogonal as determined by decision block 110, then principal components analysis is performed at block 106 with the assumption that r eigenvectors are selected from that step. Even if there were no non-interval features input, the principal components step 106 is most often followed, since one can usually not assume that real-world data is already orthogonal. The principal components step 106 generates orthogonal components which then correspond to axes in the resulting metric space. Additionally, the principal components step 106 allows one to arbitrarily restrict the number of dimensions resulting in the nearest neighbor space to whatever r one chooses, keeping in mind that the present invention will perform best with relatively small dimensionality After the principal components step 106, the data is stored at block 108 in a tree in accordance with the teachings of the present invention before processing terminates at end block 110.

If the principal components step 106 is not needed, due to orthogonal interval-scaled inputs in the original data, then decision block 112 examines whether the inputs are standardized. If they are, then the resulting projections of the data are stored at block 108 in the tree in accordance with the teachings of the present invention. If they are not, then the inputs are standardized at block 114 before they are stored in the tree. Processing terminates at end block 110.

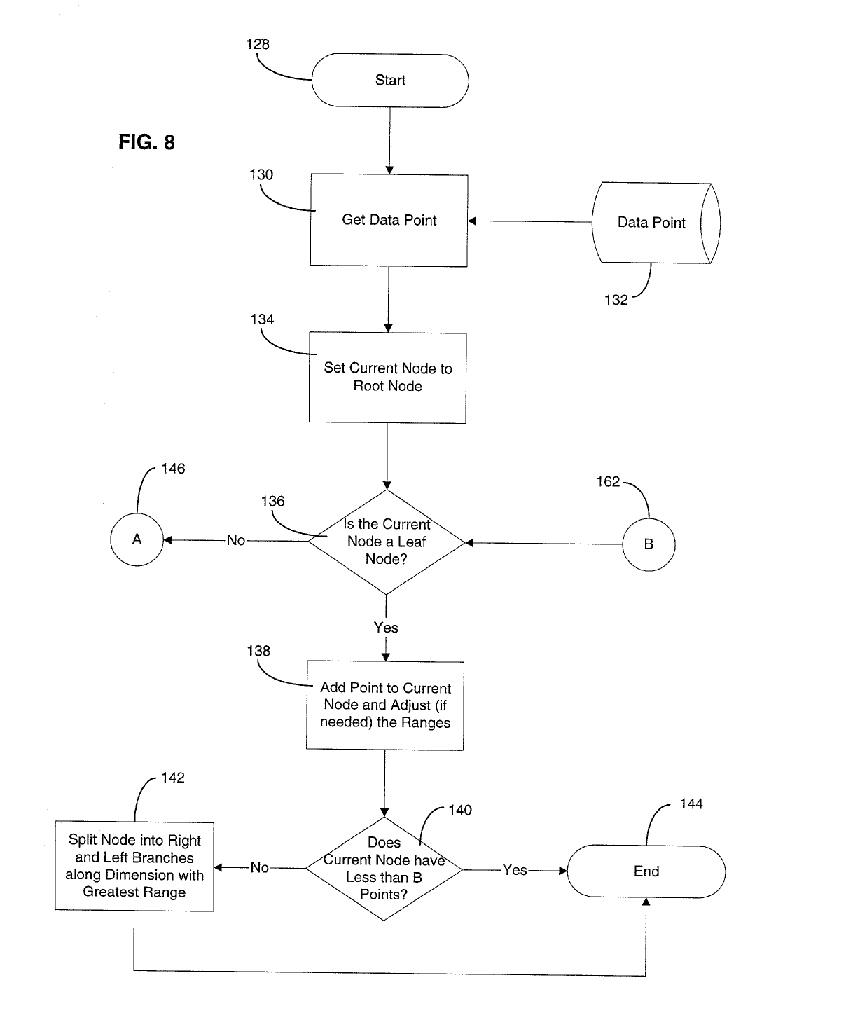

FIG. 8 is a flow chart depicting the steps to add a point to the tree of the present invention. Start block 128 indicates that block 130 obtains data point 132. This new data point 132 is an array of n real-valued attributes. Each of these attributes is referred to as a dimension of the data. Block 134 sets the current node to the root node. A node contains the following information: whether it is a branch (no child nodes) or leaf (it has two children nodes), and how many points are contained in this node and all its descendants. If it is a leaf, it also contains a list of the points contained therein. The root node is the beginning node in the tree and it has no parents. Instead of storing the splitting value on branches as in a KD-tree, the present invention stores the minimum and maximum values (i.e., the range) for the points in the subnodes and stores descendants along the dimension that its parent was split.

Decision block 136 examines whether the current node is a leaf node. If it is, block 138 adds data point 132 to the current node. This concatenates the input data point 132 at the end of the list of points contained in the current node. Moreover, the minimum value is updated if the current point is less than the minimum, or the maximum value is updated if the current point's value is greater than the maximum.

Decision block 140 examines whether the current node has less than B points. B is a constant defined before the tree is created. It defines the maximum number of points that a leaf node can contain. An exemplary value for B is eight. If the current node does have less than B points, then processing terminates at end block 144.

However, if the current node does not have less than B points, block 142 splits the node into right and left branches along the dimension with the greatest range. In this way, the present invention has partitions along only one axis at a time, and thus it does not have to process more than one dimension at every split.

All n dimensions are examined to determine the one with the greatest difference between the minimum value and the maximum value for this node. Then that dimension is split along the two points closest to the median value—all points with a value less than the value will go into the left-hand branch, and all those greater than or equal to that value will go into the right-hand branch. The minimum value and the maximum value are then set for both sides. Processing terminates at end block 144 after block 142 has been processed.

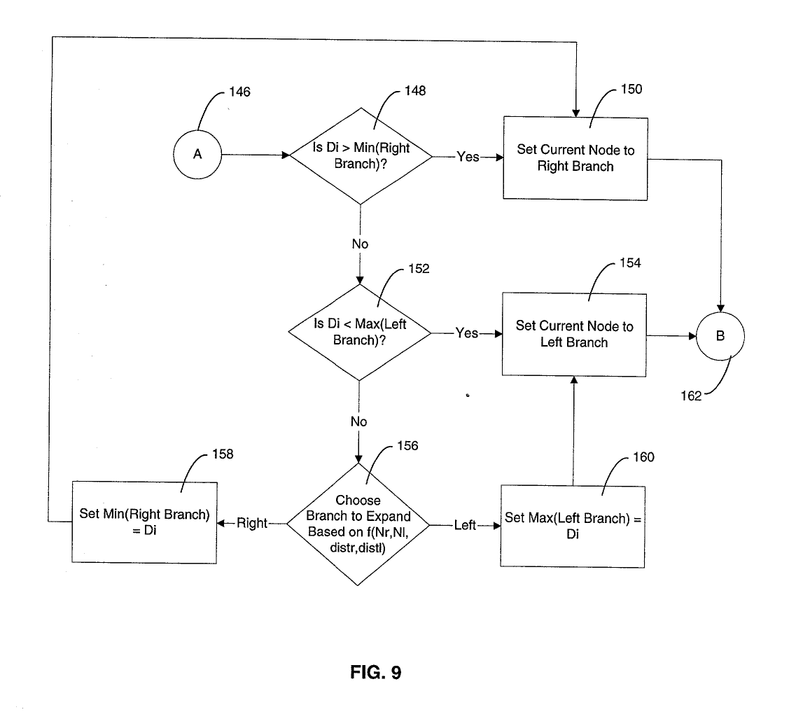

If decision block 136 determines that the current node is not a leaf node, processing continues on FIG. 9 at continuation block 146. With reference to FIG. 9, decision block 148 examines whether Dᵢ is greater than the minimum of the right branch (note that Dᵢ refers to the value for the new point on the dimension with the greatest range). If Dᵢ is greater than the minimum, block 150 sets the current node to the right branch, and processing continues at continuation block 162 on FIG. 8.

If Dᵢ is not greater than the minimum of the right branch as determined by decision block 148, then decision block 152 examines whether Dᵢ is less than the maximum of the left branch. If it is, block 154 sets the current node to the left branch and processing continues on FIG. 8 at continuation block 162.

If decision block 152 determines that Dᵢ is not less than the maximum of the left branch, then decision block 156 examines whether to select the right or left branch to expand. Decision block 156 selects the right or left branch based on the number of points on the right-hand side (Nᵣ), the number of points on the left-hand side (Nₗ), the distance to the minimum value on the right-hand side (distᵣ), and the distance to the maximum value on the left-hand side (distₗ). When Dᵢ is between the separator points for the two branches, the decision rule is to place a point in the right-hand side if (Distₗ/Distᵣ)(Nₗ/Nᵣ)>1. Otherwise, it is placed on the left-hand side. If it is placed on the right-hand side, then process block 158 sets the minimum of the right branch to Dᵢ and process block 150 sets the current node to the right branch before processing continues at continuation block 162. If the left branch is chosen to be expanded, then process block 160 sets the maximum of the left branch to D_{i.} Process block 154 then sets the current node to the left branch before processing continues at continuation block 162 on FIG. 8.

With reference back to FIG. 8, continuation block 162 indicates that decision block 136 examines whether the current node is a leaf node. If it is not, then processing continues at continuation block 146 on FIG. 9. However, if the current node is a leaf node, then processing continues at block 138 in the manner described above.

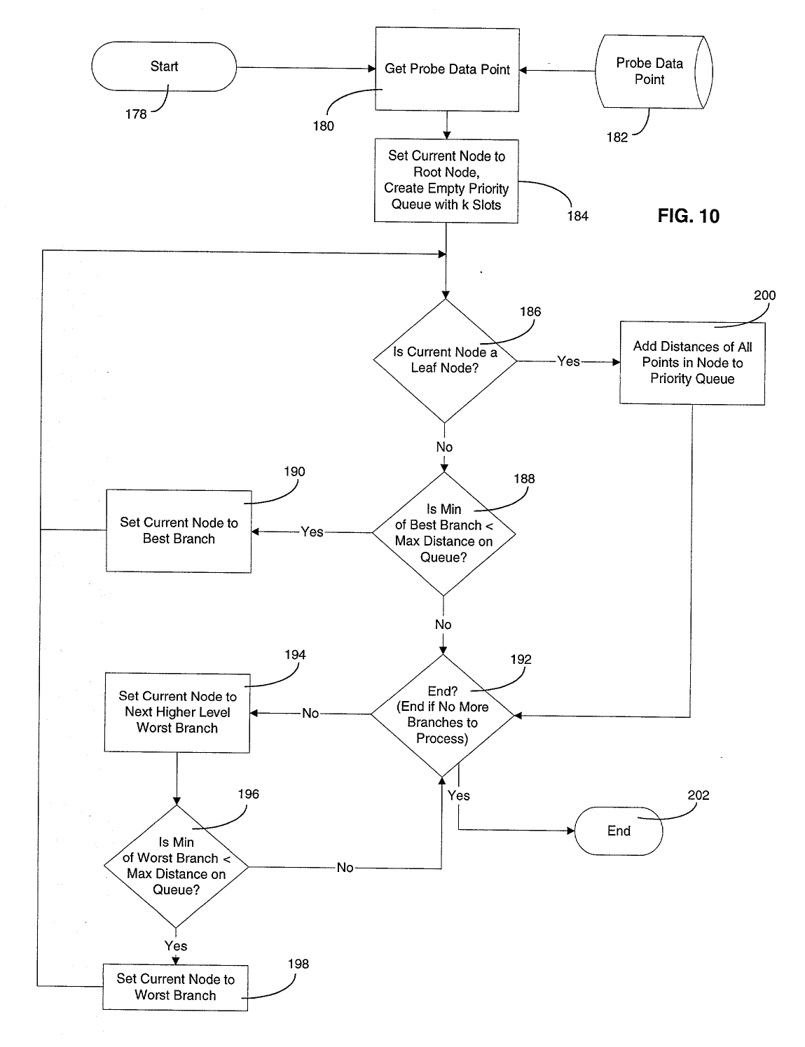

FIG. 10 is a flow chart depicting the steps to find the nearest neighbors given a probe data point 182. Start block 178 indicates that block 180 obtains a probe data point 182. The probe data point 182 is an array of n real-valued attributes. Each attribute denotes a dimension. Block 184 sets the current node to the root node and creates an empty queue with k slots. A priority queue is a data representation normally implemented as a heap. Each member of the queue has an associated real value, and items can be popped off the queue ordered by this value. The first item in the queue is the one with the largest value. In this case, the value denotes the distance between the probe point 182 and the point that is stored in that slot. The k slots denote the queue's size, in this case, it refers to the number of nearest neighbors to detect.

Decision block 186 examines whether the current node is a leaf node. If it is not, then decision block 188 examines whether the minimum of the best branch is less than the maximum distance on the queue. For this examination in decision block 188, “i” is set to be the dimension on which the current node is split, and Dᵢ is the value of the probe data point 182 along that dimension. The minimum distance of the best branch is computed as follows:

$$Min {dist}_{i} = \{ \begin{matrix}0 ; if {min}_{i} \leq {D}_{i} \leq {max}_{i} \\ {( {min}_{i} - {D}_{i} )}^{2} , if {min}_{i} > {D}_{i} for both the left and the right branches \\ {( {max}_{i} - {D}_{i} )}^{2} , otherwise\end{matrix}$$

Whichever is smaller is used for the best branch, the other being used later for the worst branch. An array having of all these minimum distance values is maintained as we proceed down the tree, and the total squared Euclidean distance is:

$$totdist = {\sum }_{j = 1}^{n} Min {dist}_{j}$$

Since this is incrementally maintained, it can be computed much more quickly as totdist (total distance)=Min dist_{i, old}+Min dist_{i, new}. This condition evaluates to true if totdist is less than the value of the distance of the first slot on the priority queue, or the queue is not yet full.

If the minimum of the best branch is less than the maximum distance on the priority queue as determined by decision block 188, then block 190 sets the current node to the best branch so that the best branch can be evaluated. Processing then branches to decision block 186 to evaluate the current best node.

However, if decision block 188 determines that the minimum of the best branch is not less than the maximum distance on the queue, then decision block 192 determines whether processing should terminate. Processing terminates at end block 202 when no more branches are to be processed (e.g., if higher level worst branches have not yet been examined).

If more branches are to be processed, then processing continues at block 194. Block 194 set the current node to the next higher level worst branch. Decision block 196 then evaluates whether the minimum of the worst branch is less than the maximum distance on the queue. If decision block 196 determines that the minimum of the worst branch is not less than the maximum distance on the queue, then processing continues at decision block 192.

Note that as we descend the tree, we maintain the minimum squared Euclidean distance for the current node, as well as an n-dimensional array containing the square of the minimum distance for each dimension split on the way down the tree. A new minimum distance is calculated for this dimension by setting it to the square of the difference of the value for that dimension for the probe data point 182 and the split value for this node. Then we update the current squared Euclidean distance by subtracting the old value of the array for this dimension and adding the new minimum distance. Also, the array is updated to reflect the new minimum value for this dimension. We then check to see if the new minimum Euclidean distance is less than the distance of the first item on the priority queue (unless the priority queue is not yet full, in which case it always evaluates to yes).

If decision block 196 determines that the minimum of the worst branch is not less than the maximum distance on the queue, then processing continues at block 198 wherein the current node is set to the worst branch. Processing continues at decision block 186.

If decision block 186 determines that the current node is a leaf node, block 200 adds the distances of all points in the node to the priority queue. In this way, the distances of all points in the node are added to the priority queue. The squared Euclidean distance is calculated between each point in the set of points for that node and the probe point 182. If that value is less than or equal to the distance of the first item in the queue, or the queue is not yet full, the value is added to the queue. Processing continues at decision block 192 to determine whether additional processing is needed before terminating at end block 202.

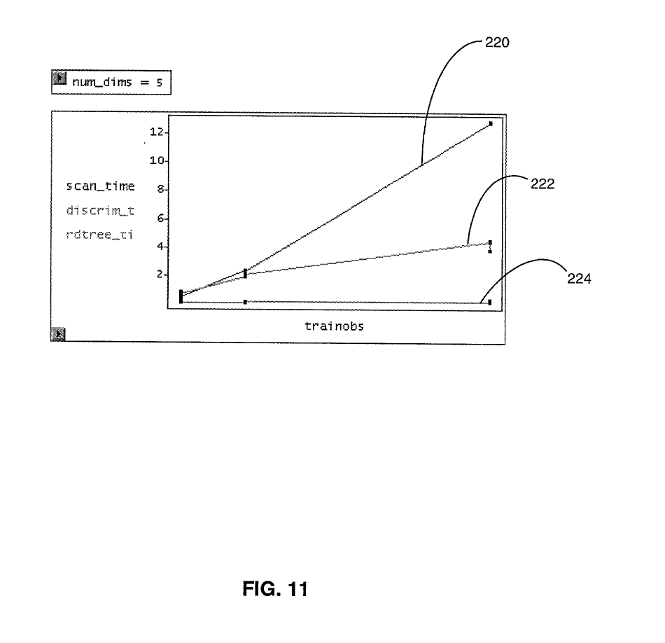

This method and system of the present invention's tree construction and nearest neighbor finding technique results in a radical reduction in the number of nodes examined, particularly for “small” dimensionality. FIGS. 11-13 are graphs that compare the speed of nearest neighbor matching for the scanning approach 220, KD-Tree approach 222, and the present invention's approach 224 for different numbers of dimensions using entirely random data.

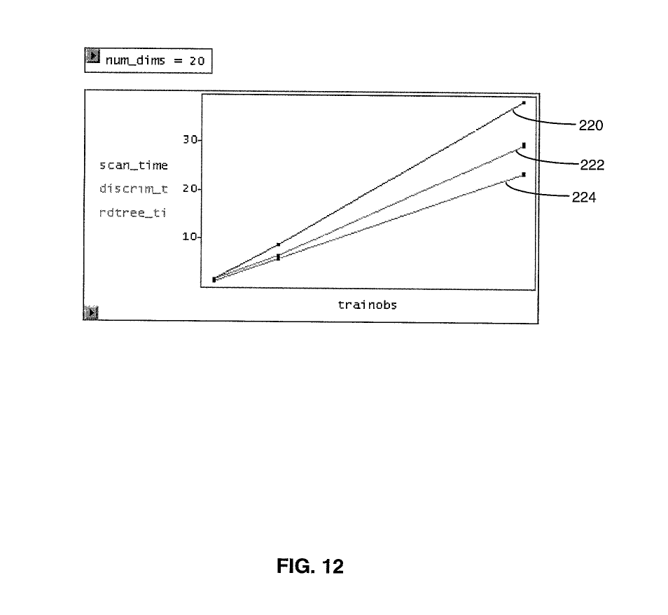

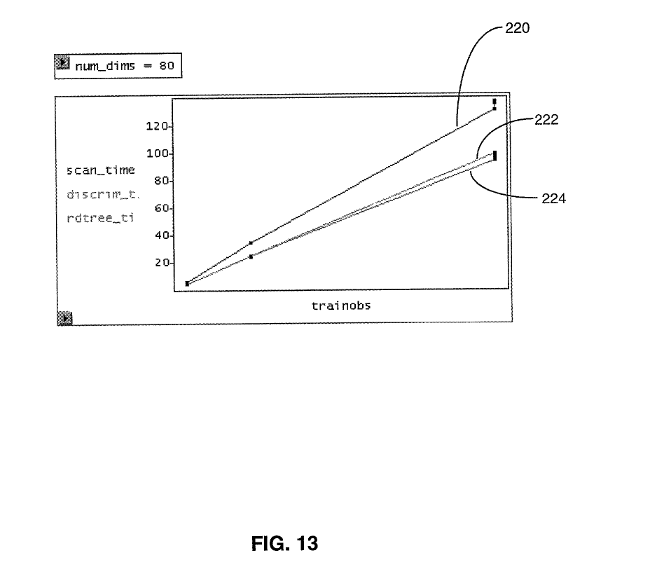

FIG. 11 depicts the comparison at five dimensions. FIG. 12 depicts the comparison at twenty dimensions. FIG. 13 depicts the comparison at eighty dimensions. The x-axis denotes the number of training observations stored, and the y-axis denotes the time to detect two nearest neighbors. Note that in all cases, the present invention outperforms all the others, but the effect is especially pronounced at small dimensionality. In fact, at a dimensionality of five, the present invention seems to perform at about the same speed regardless of the number of training examples.

These examples show that the preferred embodiment of the present invention can be applied to a variety of situations. However, the preferred embodiment described with reference to the drawing figures is presented only to demonstrate such examples of the present invention. Additional and/or alternative embodiments of the present invention should be apparent to one of ordinary skill in the art upon reading this disclosure. For example, the present invention includes not only binary trees, but trees that include more than one split. FIG. 3 depicts a tree having more than one split as shown by reference numeral 56. Within region 56, tree 32 splits into three subnodes. The maximum and minimum values of the subnodes are maintained in accordance with the present invention and used to search for nearest neighbors.

It is claimed:

1. A computer-implemented set query method that searches for data points neighboring a probe data point, comprising the steps of:
receiving a set query that seeks neighbors to a probe data point;
evaluating nodes in a data tree to determine which data points neighbor a probe data point,
wherein the nodes contain the data points,
wherein the nodes are associated with ranges for the data points included in their respective branches; and
determining which data points neighbor the probe data point based upon the data point ranges associated with a branch.

2. The method of claim 1 further comprising the step of:
determining distances between the probe data point and the data points of the tree based upon the ranges.

3. The method of claim 2 further comprising the step of:
determining nearest neighbors to the probe data point based upon the determined distances.

4. The method of claim 1 further comprising the steps of:
determining distances between the probe data point and the data points of the tree based upon the ranges; and
selecting as nearest neighbors a preselected number of the data points whose determined distances are less than the remaining data points.

5. The method of claim 1 further comprising the steps of:
selecting based upon the ranges which data points to determine distances from the probe data point;
determining distances between the probe data point and the selected data points of the tree; and
selecting as nearest neighbors a preselected number of the data points whose determined distances are less than the remaining data points.

6. The method of claim 5 wherein the ranges include minimum and maximum data point information for the nodes, said method further comprising the steps of:
selecting based upon the minimum and maximum data point information which data points to determine distances from the probe data point;
determining distances between the probe data point and the selected data points of the tree; and
selecting as nearest neighbors a preselected number of data points whose determined distances are less than the remaining data points.

7. The method of claim 1 wherein the ranges include minimum and maximum data point information for the nodes, said method further comprising the steps of:
selecting based upon the minimum and maximum data point information which data points to determine distances from the probe data point;
determining distances between the probe data point and the selected data points of the tree; and
selecting as nearest neighbors a preselected number of data points whose determined distances are less than the remaining data points.

8. The method of claim 1 wherein the data tree includes a root node, subnodes, and leaf nodes to contain the data points and the ranges, wherein the tree contains a split into first and second subnodes, wherein the first and second subnodes contain minimum and maximum data point information for the data points included in their respective branches, said method further comprising the steps of:
selecting the branch of the first subnode when the probe data point is less than the minimum of the first subnode;
determining distances between the probe data point and at least one data point contained in the branch of the first subnode; and
selecting as a nearest neighbor at least one data point in the first subnode branch whose determined distance is less than another data point contained in the branch of the first subnode.

9. The method of claim 8 further comprising the step of:
selecting as a nearest neighbor at least one data point in the first subnode branch whose determined distance is less than another data point contained in the branch of the second subnode.

10. The method of claim 1 wherein the data tree includes a root node, subnodes, and leaf nodes to contain the data points and the ranges, wherein the tree contains a split into first and second subnodes, wherein the first and second subnodes contain minimum and maximum data point information for the data points included in their respective branches, said method further comprising the steps of:
selecting the branch of the second subnode when the probe data point is greater than the maximum of the second subnode;
determining distances between the probe data point and at least one data point contained in the branch of the second subnode; and
selecting as a nearest neighbor at least one data point in the second subnode branch whose determined distance is less than another data point contained in the branch of the second subnode.

11. The method of claim 10 further comprising the step of:
selecting as a nearest neighbor at least one data point in the second subnode branch whose determined distance is less than another data point contained in the branch of the first subnode.

12. The method of claim 1 wherein the data tree includes a root node, subnodes, and leaf nodes to contain the data points and the ranges, wherein the tree contains a split into first and second subnodes, wherein the first and second subnodes contain minimum and maximum data point information for the data points included in their respective branches, said method further comprising the steps of:
determining when the probe data point is between the maximum of the first subnode and the minimum of the second subnode;
when the probe data point is between the maximum of the first subnode and the minimum of the second subnode, selecting the branch of either the first subnode or second subnode based upon which branch has the smallest minimum distance to expand;
determining distances between the probe data point and at least one data point contained in the selected branch; and
selecting as a nearest neighbor at least one data point in the selected branch whose determined distance is less than another data point contained in the other branch.

13. The method of claim 1 further comprising the step of:
constructing the data tree by partitioning the data points from a database into regions.

14. The method of claim 1 further comprising the steps of:
determining that the data points are categorical data points;
scaling the categorical data points into variables that are interval-scaled; and
storing the scaled categorical data points in the data tree.

15. The method of claim 1 further comprising the steps of:
determining that the data points are non-interval data points;
scaling the non-interval data points into variables that are interval-scaled; and
storing the scaled data points in the data tree.

16. The method of claim 1 further comprising the steps of:
performing principal components analysis upon the data points to generate orthogonal components; and
storing the orthogonal components in the data tree.

17. The method of claim 1 wherein the data points are an array of real-valued attributes, wherein the attributes represent dimensions, said method further comprising the step of:
constructing the data tree by storing in a node the range of the data points within the branch of the node and storing descendants of the node along the dimension that its parent node was split.

18. The method of claim 1 wherein the data points are an array of real-valued attributes, wherein the attributes represent dimensions, said method further comprising the step of:
constructing the data tree by storing in a node the minimum and maximum of the data points within the branch of the node.

19. The method of claim 18 further comprising the step of:
constructing the data tree by splitting a node into a left and right branch along the dimension with greatest range.

20. The method of claim 19 further comprising the step of:
selecting the right branch of the data tree to add a data point when the probe data point is greater than the minimum of the right branch.

21. The method of claim 19 further comprising the step of:
selecting the left branch of the data tree to add a data point when the probe data point is less than the maximum of the left branch.

22. The method of claim 19 further comprising the step of:
selecting either the left or right branch of the data tree to add a data point based on the number of points on the right branch, the number of points on the left branch, the distance to the minimum value on the right branch, and the distance to the maximum value on the left branch.

23. The method of claim 19 further comprising the step of:
constructing the data tree by partitioning along only one axis the data points into regions.

24. The method of claim 1 wherein the data points are stored in the data tree in a volatile computer memory, said method further comprising the step of:
evaluating the nodes in the data tree that are stored in the volatile computer memory.

25. The method of claim 1 wherein the data points are stored in the data tree in a random access memory, said method further comprising the step of:
evaluating the nodes in the data tree that are stored in the random access memory.

26. A computer-implemented apparatus that searches for data points neighboring a probe data point, comprising:
a data tree having nodes that contain the data points,
wherein the nodes are associated with ranges for the data points included in their respective branches; and
a node range searching function module connected to the data tree in order to evaluate the ranges associated with the nodes to determine which data points neighbor a probe data point.

27. The apparatus of claim 26 wherein the distances are determined between the probe data point and the data points of the tree based upon the ranges, said apparatus further comprising:
a priority queue connected to the node range searching function module, wherein the priority queue contains storage locations for points having a preselected minimum distance from the probe data point.

28. The apparatus of claim 27 wherein the nearest neighbors to the probe data point are selected based upon the determined distances that are stored in the priority queue.

29. The apparatus of claim 26 wherein the ranges include minimum and maximum data point information for the nodes, wherein the node range searching function module selects based upon the minimum and maximum data point information which data points to determine distances from the probe data point, wherein the node range searching function module determines distances between the probe data point and the selected data points of the tree, wherein a preselected number of data points are selected as nearest neighbors whose determined distances are less than the remaining data points.

30. The apparatus of claim 26 wherein the data tree includes a root node, subnodes, and leaf nodes to contain the data points and the ranges, wherein the tree contains a split into first and second subnodes, wherein the first and second subnodes contain minimum and maximum data point information for the data points included in their respective branches,
wherein the branch of the first subnode is selected when the probe data point is less than the minimum of the first subnode,
wherein the distance is determined between the probe data point and at least one data point contained in the branch of the first subnode, and
wherein at least one data point in the first subnode branch is selected as a nearest neighbor whose determined distance is less than another data point contained in the branch of the first subnode.

31. The apparatus of claim 30 wherein at least one data point in the first subnode branch is selected as a nearest neighbor whose determined distance is less than another data point contained in the branch of the second subnode.

32. The apparatus of claim 26 wherein the data tree includes a root node, subnodes, and leaf nodes to contain the data points and the ranges, wherein the tree contains a split into first and second subnodes, wherein the first and second subnodes contain minimum and maximum data point information for the data points included in their respective branches,
wherein the branch of the second subnode is selected when the probe data point is greater than the maximum of the second subnode,
wherein a distance is determined between the probe data point and at least one data point contained in the branch of the second subnode, and
wherein at least one data point in the second subnode branch is selected as a nearest neighbor whose determined distance is less than another data point contained in the branch of the second subnode.

33. The apparatus of claim 32 wherein at least one data point in the second subnode branch is selected as a nearest neighbor whose determined distance is less than another data point contained in the branch of the first subnode.

34. The apparatus of claim 26 wherein the data tree includes a root node, subnodes, and leaf nodes to contain the data points and the ranges, wherein the tree contains a split into first and second subnodes, wherein the first and second subnodes contain minimum and maximum data point information for the data points included in their respective branches, said method further comprising:
means for determining when the probe data point is between the maximum of the first subnode and the minimum of the second subnode;
when the probe data point is between the maximum of the first subnode and the minimum of the second subnode, selecting the branch of either the first subnode or second subnode based upon which branch has the smallest minimum distance to expand;
means for determining distances between the probe data point and at least one data point contained in the selected branch; and
means for selecting as a nearest neighbor at least one data point in the selected branch whose determined distance is less than another data point contained in the other branch.

35. The apparatus of claim 26 wherein the data points are an array of real-valued attributes, wherein the attributes represent dimensions, wherein the data tree contains in a node the range of the data points within the branch of the node and storing descendants of the node along the dimension that its parent node was split.

36. The apparatus of claim 26 wherein the data points are an array of real-valued attributes, wherein the attributes represent dimensions, wherein the data tree contains in a node the minimum and maximum of the data points within the branch of the node.

37. The apparatus of claim 36 further comprising wherein the data tree contains splits for the nodes, wherein the splits are along the dimension with greatest range.

38. The apparatus of claim 37 further comprising:
a point adding function module connected to the data tree in order to select the right branch of the data tree to add a data point when the probe data point is greater than the minimum of the right branch.

39. The apparatus of claim 37 further comprising:
a point adding function module connected to the data tree in order to select the left branch of the data tree to add a data point when the probe data point is less than the maximum of the left branch.

40. The apparatus of claim 37 further comprising:
a point adding function module connected to the data tree in order to select either the left or right branch of the data tree to add a data point based on the number of points on the right branch, the number of points on the left branch, the distance to the minimum value on the right branch, and the distance to the maximum value on the left branch.

41. The apparatus of claim 26 further comprising a volatile computer memory to store the data points.

42. The apparatus of claim 26 further comprising a random access memory to store the data points.

43. A computer memory to store a data tree data structure for use in searching for data points neighboring a probe data point, comprising:
the data tree data structure that contains nodes,
wherein the nodes include a root node, subnodes, and leaf nodes in order to contain the data points,
wherein the data tree data structure contains a split into first and second subnodes, wherein the first and second subnodes contain minimum and maximum data point information for the data points included in their respective branches,
wherein the ranges of the data tree data structure are evaluated in order to determine which data points in the data tree data structure neighbor a probe data point.

44. The memory of claim 43 wherein the computer memory is a volatile computer memory.

45. The memory of claim 43 wherein the computer memory is a random access memory.
